(19) United States
(12) Patent Application Publication
(10) Pub. No.: US 2015/0220514 A1
(43) Pub. Date: Aug. 6, 2015

(54) DATA PROCESSING SYSTEMS INCLUDING A TRANSLATION INPUT METHOD EDITOR

(71) Applicant: CA, INC., Islandia, NY (US)

(72) Inventor: Kai Zhang, Beijing (CN)

(73) Assignee: CA, INC., Islandia, NY (US)

(21) Appl. No.: 14/172,252

(22) Filed: Feb. 4, 2014

(51) Int. Cl. G06F 17/28

(52) U.S. Cl. CPC G06F 17/289

(57) ABSTRACT

A method includes operating a translation input method editor on a data processing system to receive a first word in a first language at an input method editor, generate a second word in a second language that has a defined corresponding meaning as the first word in the first language, and display the second word in the second language.

### BACKGROUND

The present disclosure relates to computing systems, and, in particular, to input method editors used in data processing systems.

An input method editor is an input method on a data processing system that allows a user to use a keyboard or keypad to input characters and symbols for languages that are not compatible with the keyboard/keypad. The input method is typically an operating system component or program and allows the user to enter data as input. The data may be keyboard strokes, mouse movements, touch pad movements, and the like. One use of an input method is to allow the user of a Latin keyboard to input Chinese, Japanese, Korean, and Indic characters. In a mobile application, for example, an input method may be used to allow a user to enter Latin alphabet characters (or alphabet characters from another language) via a numeric keypad. Chinese, Japanese, and Korean (CJK) languages, however, may include thousands of characters and symbols. As a result, various techniques have been developed for using the twenty-six English characters on a Latin keyboard to input CJK language characters. These techniques include Chinese Pinyin and Wubi and Japanese Hiragana. The Chinese Pinyin input method is phonetic based. As shown in the example of FIG. 1, a user types a word or phrase using English characters that corresponds to the way the word or phrase sounds in Chinese and the input editor provides a list of potential words/phrases for the user to select from. The Chinese Wubi input method is shape-based. As shown in the example of FIG. 2, various keys on a Latin keyboard can be associated with various shapes and symbols that are used to form Chinese words and phrases. A person learning a new language, however, may not have an extensive knowledge of the sounds comprising the correct pronunciations of various words and phrases of the new language. Similarly, a person learning new language may not have an extensive knowledge of the shapes and symbols that comprise the new language. As a result, phonetic-based and/or shape-based input methods may have limited value for some users.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### SUMMARY

In some embodiments of the inventive subject matter, a method comprises performing on a processor operations as follows: receiving a first word in a first language at an input method editor, generating a second word in a second language that has a similar meaning as the first word in the first language, and displaying the second word in the second language.

In other embodiments, generating the second word in the second language comprises generating a plurality of words in the second language that have a similar meaning as the first word in the first language. Displaying the second word in the second language comprises displaying the plurality of words in the second language. And the method further comprises receiving a selection of one of the plurality of words in the second language.

In still other embodiments, receiving the input text comprises receiving a first plurality of words in the first language. Generating the second word in the second language comprises generating a second plurality of words in the second language that have a similar meaning as the first plurality of words in the first language. And the method further comprises displaying the second plurality of words in the second language.

In still other embodiments, the first language is English and the second language uses CJK characters.

In further embodiments of the inventive subject matter, a system comprises a processor and a memory coupled to the processor and comprising computer readable program code embodied in the memory that when executed by the processor causes the processor to perform operations comprising: receiving a first word in a first language at an input method editor, generating a second word in a second language that has a similar meaning as the first word in the first language, and displaying the second word in the second language.

In other embodiments, a computer program product comprises a tangible computer readable storage medium comprising computer readable program code embodied in the medium that when executed by a processor causes the processor to perform operations comprising: receiving a first word in a first language at an input method editor, generating a second word in a second language that has a similar meaning as the first word in the first language, and displaying the second word in the second language.

Other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a display diagram that illustrates operations of a phonetic-based input method editor;

FIG. 2 is a display diagram that illustrates operations of a shape-based input method editor;

FIG. 3 is a block diagram that illustrates a data processing system including a translation input method editor module in accordance with some embodiments of the present inventive subject matter;

FIG. 4 is a block diagram that illustrates a software/hardware architecture for a translation input method editor in a data processing system in accordance with some embodiments of the present inventive subject matter;

FIG. 5 is a flowchart that illustrates operations of a translation input method editor for translating words in accordance with some embodiments of the present inventive subject matter;

FIG. 6 is a display diagram that illustrates operations of a translation input method editor for translating words in accordance with some embodiments of the present inventive subject matter;

FIG. 7 is a flowchart that illustrates operations of a translation input method editor for translating phrases/sentences in accordance with some embodiments of the present inventive subject matter;

FIG. 8 is a display diagram that illustrates operations of a translation input method editor for translating phrases/sentences in accordance with some embodiments of the present inventive subject matter; and

FIGS. 9 and 10 are display diagrams that illustrate operations of a translation input method editor in conjunction with a phonetic-based input method editor for translating words and phrases/sentences, respectively, in accordance with some embodiments of the inventive subject matter.

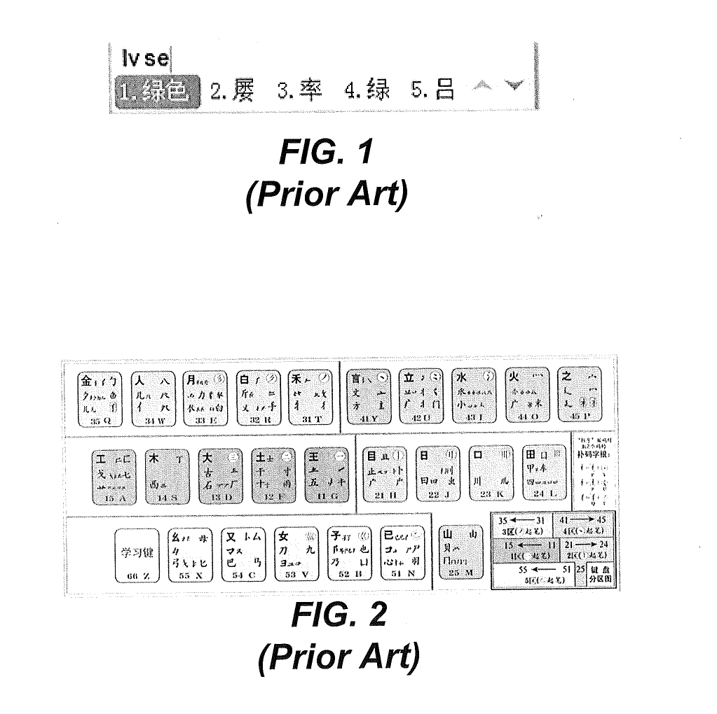

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

As used herein, a “sentence” means a grammatical unit consisting of one or more words that are grammatically linked.

As used herein, a “phrase” means any group of words that function as a single unit in the syntax of a sentence.

As used herein, “CJK” is a collective term for representing any language that completely or partly use Chinese characters, e.g., Hànzì in Chinese, kanji in Japanese, and hanja in Korean.

As used herein, a “phonetic-based input method editor” is an input method editor that generates a character, symbol, phrase, clause, word, and/or sentence in a target language based on a phonetic representation of the character, symbol, phrase, clause, word, and/or sentence in the target language in a source language. An example of a phonetic-based input method editor is an input method editor based on the Chinese pinyin input method.

As used herein, a “shape-based input method editor” is an input method editor that generates a character, symbol, phrase, clause, word, and/or sentence in a target language based on the selection of one or more root shapes to construct the character, symbol, phrase, clause, word, and/or sentence. An example of a shape-based input method editor is an input method editor based on the Chinese wubi input method.

Conventional input method editors provide the ability of a user to input CJK characters using a Latin keyboard. These input method editors are generally based on phonetic-based input methods or shape-based input methods, which require the user to have some knowledge of the proper sound of the words, phrases, etc. of the target language or the character construction of the target language. For a user with limited expertise in the target language, it may be difficult to generate words, phrases, sentences and the like in the target language using a conventional input method editor due to a lack of knowledge of the sounds, grammar, vocabulary, and/or character structure. Some embodiments of the inventive subject matter provide an translation input method editor in which the user can center a word, phrase, sentence, or the like in a first language and the translation input method editor generates a word, phrase, sentence or the like in a second language that has a defined corresponding meaning to the information input in the first language. A user, therefore, need not have an advanced understanding of the sounds, character structure, vocabulary, grammar, etc. of the second language when providing the text for translation. Instead, the user can enter characters, words, phrases, clauses, sentences and the like in a first language in which the user is fluent. In some embodiments, the user is presented with multiple words, phrases, sentence, or the like as possible choices for having the same meaning as the information that is input. This may allow the user to select the word, phrase, or sentence in the second language that has the closest meaning to the information input in the first language.

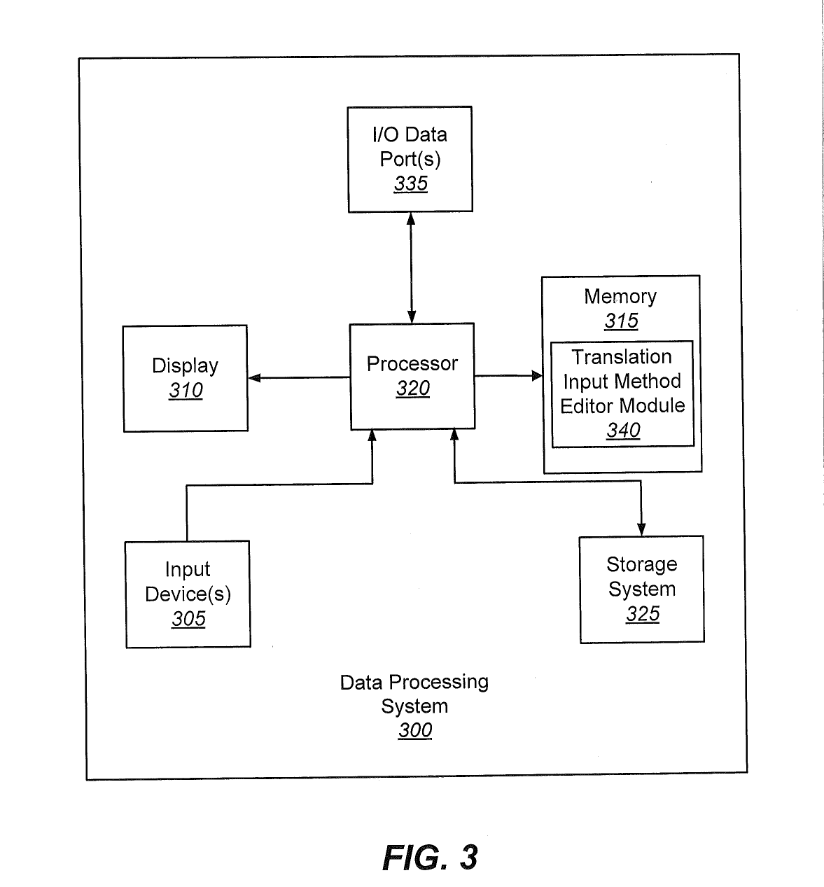

FIG. 3 illustrates a data processing system 300 that may include a translation input method editor in accordance with some embodiments of the inventive subject matter. The data processing system 300 comprises input device(s) 305, such as a keyboard or keypad, a display 310, and a memory 315 that communicate with a processor 320. The data processing system 300 may further comprise a storage system 325, and an I/O data port(s) 335 that also communicate with the processor 320. The storage system 325 may include removable and/or fixed media, such as floppy disks, ZIP drives, hard disks, or the like as well as virtual storage such as a RAMDISK. The I/O data port(s) 335 may be used to transfer information between the data processing system 300 and another computer system or a network (e.g., the Internet). These components may be conventional components, such as those used in many conventional computing devices, and their functionality, with respect to conventional operations, is generally known to those skilled in the art. The memory 315 may be configured with a translation input method editor module 340 that may be used to support the input of information using input apparatus associated with a first language, such as a keyboard, in a second language through translation of the words, symbols, characters, phrases, clauses, sentences, and the like from the first language to the second language on the data processing system 300.

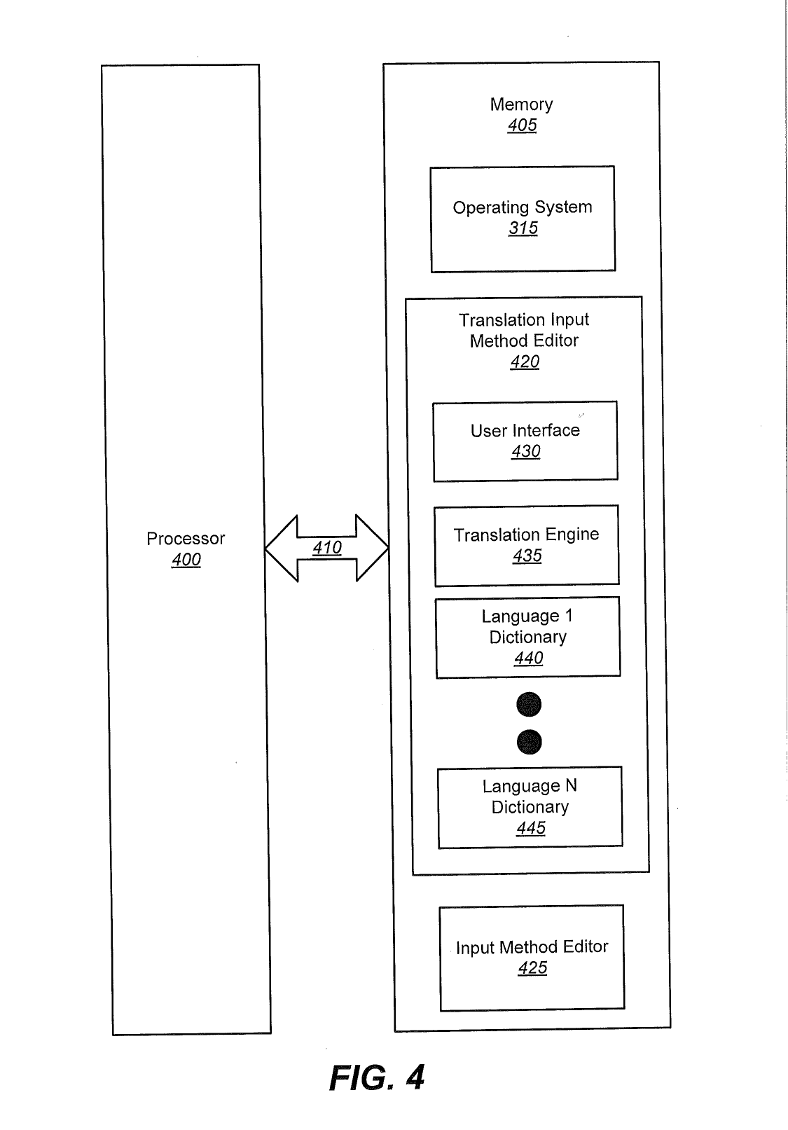

FIG. 4 illustrates a processor 400 and memory 405 that may be used in embodiments of data processing systems, such as the data processing system 300 of FIG. 3, for supporting translation through an input method editor in accordance with some embodiments of the inventive subject matter. The processor 400 communicates with the memory 405 via an address/data bus 410. The processor 400 may be, for example, a commercially available or custom microprocessor. The memory 405 is representative of the one or more memory devices containing the software and data used to provision software in accordance with some embodiments of the present invention. The memory 405 may include, but is not limited to, the following types of devices: cache, ROM, PROM, EPROM, EEPROM, flash, SRAM, and DRAM.

As shown in FIG. 4, the memory 405 may contain up to three or more categories of software and/or data: an operating system 415, a translation input method editor 420, and an input method editor 425. The operating system 415 generally controls the operation of the data processing system. In particular, the operating system 415 may manage the data processing system's software and/or hardware resources and may coordinate execution of programs by the processor 400. The translation input method editor 420 comprises a user interface module 430, a translation engine 435, and one or more language dictionaries 440, 445. The user interface 430 may allow a user to enter characters, symbols, words, phrases, sentences, and the like in a first or source language, such as the user's native language, for example. The user may enter the input information in the first language using a keyboard, keypad, mouse, etc. that is associated with the first language. The information input in the first language may be provided to the translation engine module 435. The translation engine module 435 may comprise vocabulary and grammar rules for parsing the information input via the user interface module 430. In particular, the translation engine module 435 may compare the information in the first language received through the user interface 430 and compare it with one of the language dictionaries 440, 445 associated with the first language and also with a second one of the language dictionaries 440, 445 associated with a second or target language to which the information that was input is to be translated. As part of the translation, the translation engine module 435 determines one or more characters, symbols, words, phrases, clauses, sentences, etc. in the second or target language that have a defined corresponding or same meaning as the characters, symbols, words, phrases, clauses, sentences, etc. input in the first or source language. In accordance with various embodiments of the inventive subject matter, the translation engine 435 may be implemented locally to reside in the memory 405 and to be executed by the processor 400 or may be implemented on or more remote processors that can be accessed via a communication network.

The input method editor 425 may be, for example, a phonetic-based input method editor or a shape-based input method editor and may be used, for example, to allow a user to generate input information, e.g., characters, symbols, words, phrases, clauses, sentences in a desired language, which is provided as the input information to the translation input method editor 420. For example, a user may use the input method editor 425 to generate one or more characters, symbols, words, phrases, clauses, sentences, etc. in Chinese based on information entered into the input method editor 425 in English. The Chinese information generated by the input method editor is then provided as an input to the user interface 430 or directly to the translation engine 435 to generate one or more characters, symbols, words, phrases, clauses, sentences, etc. in Korean that have a defined corresponding or same meaning to the Chinese information that was input.

Although FIG. 4 illustrates exemplary hardware/software architectures that may be used in data processing systems, such as the data processing system 300 of FIG. 3, for a translation input method editor, it will be understood that the present invention is not limited to such a configuration but is intended to encompass any configuration capable of carrying out operations described herein. Moreover, the functionality of the data processing system 300 of FIG. 3 and the hardware/software architecture of FIG. 4 may be implemented as a single processor system, a multi-processor system, a multi-core processor system, or even a network of stand-alone computer systems, in accordance with various embodiments.

Computer program code for carrying out operations of data processing systems discussed above with respect to FIG. 4 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

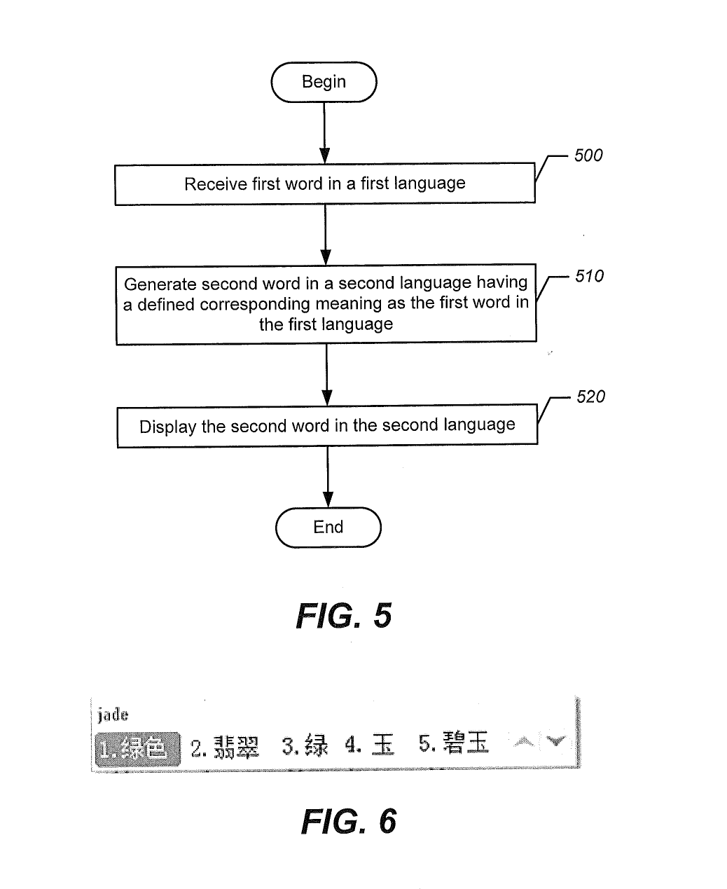

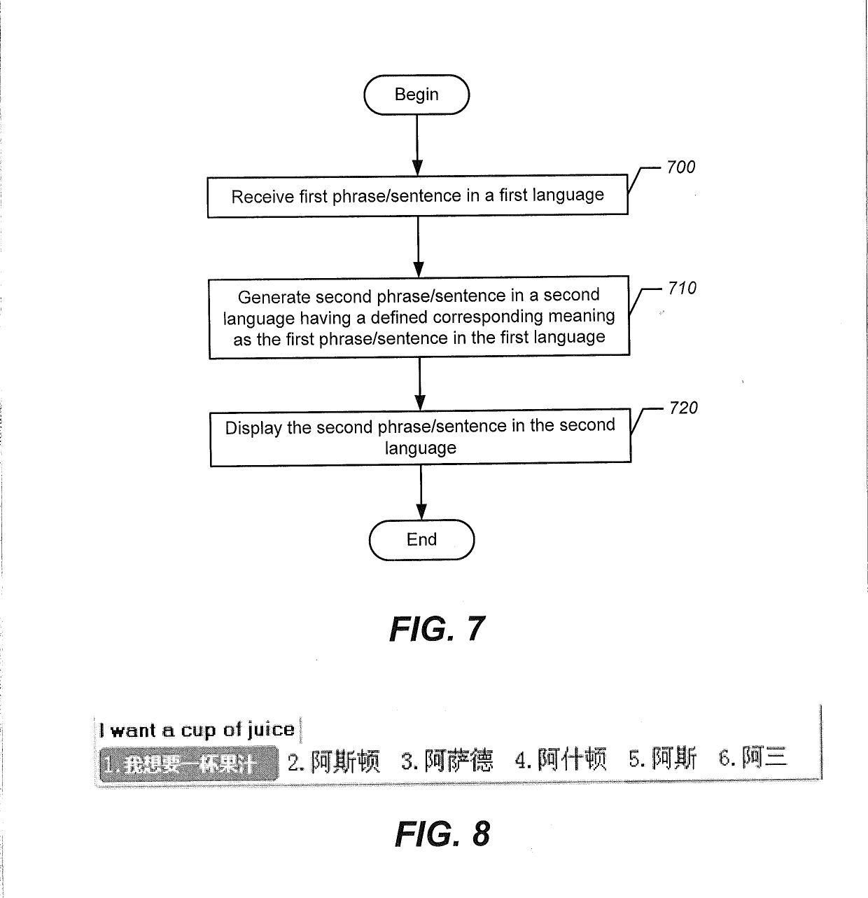

Operations of a translation input method editor according to some embodiments of the inventive subject matter will now be described with to the flow charts of FIGS. 5 and 7 and the and the display diagrams of FIGS. 6, 8, 9, and 10. Referring now to FIG. 5, operations begin at block 500 where the user interface module 430 receives a first word from a user in a first language. The translation engine 435 generates a second word in a second language that has a defined corresponding or same meaning as the first word in the first language at block 510. At block 520, the second word in the second language that was generated by the translation engine 435 is displayed. This is illustrated, for example, in FIG. 6 where a user enters the word “jade” in English. As described above with respect to block 510, the translation engine 435 may generate a word having a defined corresponding or same meaning as “jade” in a second language. In the example shown in FIG. 6, the translation engine 435 generates multiple words in Chinese that have a defined corresponding or same meaning as the word “jade.” The user may then highlight and select one of the Chinese words generated by the translation engine 435 for input to another application, such as a mail program, document processing program, browser, etc.

Referring now to FIG. 7, operations for translating phrases or sentences between a first language and a second language using a translation input method editor begin at block 700, where the user interface module 430 receives a first phrase/sentence from a user in a first language. The translation engine 435 generates a second phrase/sentence in a second language that has a defined corresponding or same meaning as the first phrase/sentence in the first language at block 710. At block 720, the second phrase/sentence in the second language that was generated by the translation engine 435 is displayed. This is illustrated, for example, in FIG. 8 where a user enters the sentence “I want a cup of juice” in English. As described above with respect to block 710, the translation engine 435 may generate a phrase/sentence having a defined corresponding or same meaning as “I want a cup of juice” in a second language. In the example shown in FIG. 8, the translation engine 435 generates multiple sentences in Chinese that have a defined corresponding or same meaning as the sentence “I want a cup of juice.” The user may then highlight and select one of the Chinese sentences generated by the translation engine 435 for input to another application, such as a mail program, document processing program, browser, etc.

In accordance with various embodiments of the inventive subject matter described above with respect to FIGS. 6-8, the first and second languages may be any languages that are supported by the translation engine 435 and language dictionaries 440, 445. In some embodiments, language support may be modular, such that dictionaries and translation engine components may be installed/uninstalled depending on what language(s) a user wishes to translate between. Supported languages may include, but are not limited to, English and languages that use CJK characters.

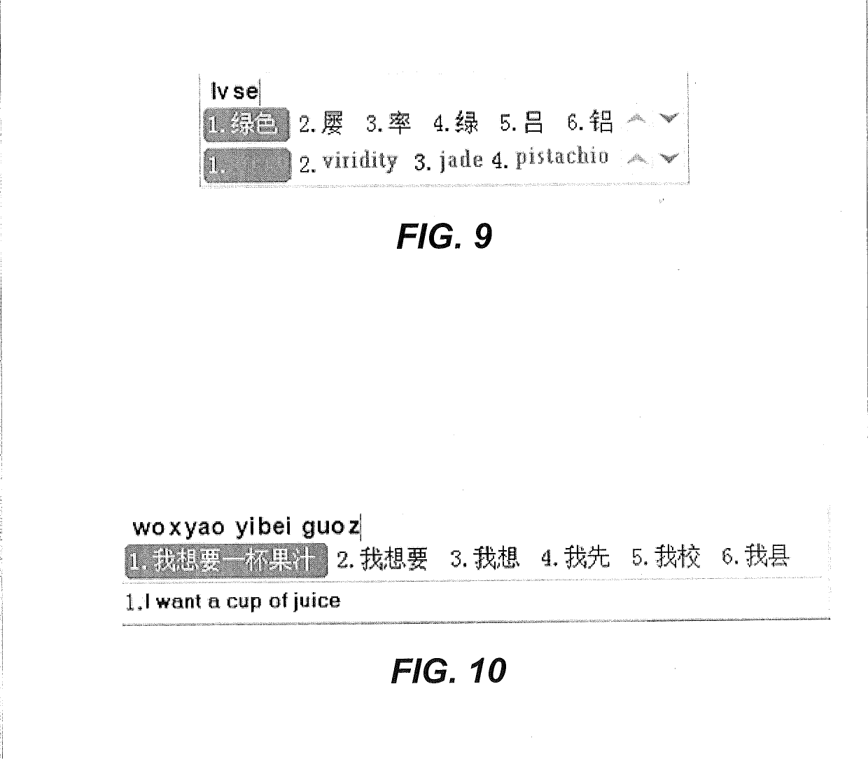

The translation input method editor 420 according to some embodiments of the inventive subject matter may be used in a conjunction with a phonetic-based or shape-based input method editor 425, for example, to provide additional flexibility in translating between languages. As shown in FIG. 9, a user may enter input text in a first language to the phonetic-based input method editor 425, which generates one or more words, phrases, etc. corresponding to the input text. In the example of FIG. 9, a user enters the phonetic sounds corresponding to a Chinese word and the input method editor 425 generates one or more Chinese words that correspond to these phonetic sounds. In the FIG. 9 example, six different Chinese words are generated corresponding to the phonetic sounds “lv se.” The user highlights the first Chinese word generated by the input method editor 425 so as to provide the first Chinese word as input to the translation input method editor 420. The translation input method editor 420 then generates one or more words in a second language that have a defined corresponding or same meaning as the Chinese word that was provided as an input as described above with respect to FIGS. 5 and 6. In the FIG. 9 example, the translation input method editor 420 generates four different English words that may have a same or defined corresponding meaning as the selected Chinese word: “green,” “viridity,” “jade,” and “pistachio,” The user may then select one of the English words for input to another application, such as a mail program, document processing program, browser, etc. In the FIG. 9 example, the user has selected the word “green.”

Referring now to FIG. 10, the translation input method editor 420 may be used in connection with the input method editor 425 to translate phrases or sentences. As shown in FIG. 10, a user may enter an input phrase or sentence in a first language to the phonetic-based input method editor 425, which generates one or more phrases, sentences, etc. corresponding to the input text. In the example of FIG. 10, a user enters the phonetic sounds corresponding to a Chinese sentence and the input method editor 425 generates one or more Chinese phrases or sentences that correspond to these phonetic sounds. In the FIG. 10 example, six different Chinese phrases or sentences are generated corresponding to the phonetic sound “woxyao yibei guoz.” The user highlights the first Chinese phrase or sentence generated by the input method editor 425 so as to provide the first Chinese phrase or sentence as input to the translation input method editor 420. The translation input method editor 420 then generates one or more phrases or sentences in a second language that have a defined corresponding or same meaning as the Chinese word that was provided as an input as described above with respect to FIGS. 7 and 8. In the FIG. 10 example, the translation input method editor 420 generates a single English sentence that may have a same or defined corresponding meaning as the selected Chinese phrase or sentence: “I want a cup of juice.” The user may then select the English phrase or sentence for input to another application, such as a mail program, document processing program, browser, etc.

FIGS. 9 and 10 illustrate operations of the input method editor 425 by way of example where the input method editor 425 is a phonetic-based input method editor. It will be understood that the input method editor 425 may be a shape-based input method editor or other type of input method editor in accordance with various embodiments of the inventive subject matter. In addition, although FIGS. 9 and 10 illustrate embodiments where the translation input method editor 420 generates English text as an output, other languages may be used to allow the user to enter information to the input method editor 425 in a first language so that the output of the input method editor 425 is in a second language. The input to the translation input method editor 420 is, therefore, in the second language and the translation input method editor 420 may generate output text in a third language.

The embodiments of methods, systems, and computer program products described herein may provide a translation input method editor that may allow a user to enter information in a source language that corresponds to the user's native language. The translation input method editor translates the entered information from the source language to a target language to generate one or more characters, words, phrases, clauses, sentences and the like having a defined corresponding or same meaning as the information entered by the user. As a result, the user does not need to be as knowledgeable about the vocabulary, grammar, phonetics, or character construction of a target language when entering the information in the source language.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

That which is claimed:

1. A method, comprising:
performing on a processor operations as follows:
receiving a first word in a first language at an input method editor;
generating a second word in a second language that has a defined corresponding meaning as the first word in the first language; and
displaying the second word in the second language.

2. The method of claim 1, wherein generating the second word in the second language comprises:
generating a plurality of words in the second language that have a defined corresponding meaning as the first word in the first language;
wherein displaying the second word in the second language comprises:
displaying the plurality of words in the second language; and
wherein the method further comprises:
receiving a selection of one of the plurality of words in the second language.

3. The method of claim 1, wherein receiving the input text comprises:
receiving a first plurality of words in the first language;
wherein generating the second word in the second language comprises:
generating a second plurality of words in the second language that have a defined corresponding meaning as the first plurality of words in the first language; and
wherein the method further comprises:
displaying the second plurality of words in the second language.

4. The method of claim 3, wherein generating the second plurality of words in the second language comprises:
generating a plurality of word groups in the second language, each of the word groups comprising a plurality of words and having a defined corresponding meaning as the first plurality of words in the first language;
wherein displaying the second plurality of words in the second language comprises:
displaying the plurality of word groups in the second language; and
wherein the method further comprises:
receiving a selection of one of the plurality of word groups in the second language.

5. The method of claim 3, wherein the first plurality of words in the first language comprises a phrase and the second plurality of words in the second language comprises a phrase.

6. The method of claim 3, wherein the first plurality of words in the first language comprises a sentence and the second plurality of words in the second language comprises a sentence.

7. The method of claim 1, wherein receiving the first word in the first language comprises:
receiving a third word in a third language; and
the method further comprises:
generating the first word in the first language based on the third word in the third language using a phonetic-based input method editor.

8. The method of claim 1, wherein receiving the first word in the first language comprises:
receiving a third word in a third language; and
the method further comprises:
generating the first word in the first language based on the third word in the third language using a shape-based input method editor.

9. The method of claim 1, wherein the first language is English and the second language uses CJK characters.

10. A system, comprising:
a processor; and
a memory coupled to the processor and comprising computer readable program code embodied in the memory that when executed by the processor causes the processor to perform operations comprising:
receiving a first word in a first language at an input method editor;
generating a second word in a second language that has a defined corresponding meaning as the first word in the first language; and
displaying the second word in the second language.

11. The system of claim 10, wherein generating the second word in the second language comprises:
generating a plurality of words in the second language that have a defined corresponding meaning as the first word in the first language;
wherein displaying the second word in the second language comprises:
displaying the plurality of words in the second language; and
wherein the operations further comprise:
receiving a selection of one of the plurality of words in the second language.

12. The system of claim 10, wherein receiving the input text comprises:
receiving a first plurality of words in the first language;
wherein generating the second word in the second language comprises:
generating a second plurality of words in the second language that have a defined corresponding meaning as the first plurality of words in the first language; and
wherein the operations further comprise:
displaying the second plurality of words in the second language.

13. The system of claim 12, wherein generating the second plurality of words in the second language comprises:
generating a plurality of word groups in the second language, each of the word groups comprising a plurality of words and having a defined corresponding meaning as the first plurality of words in the first language;
wherein displaying the second plurality of words in the second language comprises:
displaying the plurality of word groups in the second language; and
wherein the operations further comprise:
receiving a selection of one of the plurality of word groups in the second language.

14. The system of claim 12, wherein the first plurality of words in the first language comprises a phrase and the second plurality of words in the second language comprises a phrase.

15. The system of claim 12, wherein the first plurality of words in the first language comprises a sentence and the second plurality of words in the second language comprises a sentence.

16. The system of claim 10, wherein receiving the first word in the first language comprises:
receiving a third word in a third language; and
wherein the operations further comprise:
generating the first word in the first language based on the third word in the third language using a phonetic-based input method editor.

17. The system of claim 10, wherein receiving the first word in the first language comprises:
receiving a third word in a third language; and
wherein the operations further comprise:
generating the first word in the first language based on the third word in the third language using a shape-based input method editor.

18. The system of claim 10, wherein the first language is English and the second language uses CJK characters.

19. A computer program product, comprising:
a tangible computer readable storage medium comprising computer readable program code embodied in the medium that when executed by a processor causes the processor to perform operations comprising:
receiving a first word in a first language at an input method editor;
generating a second word in a second language that has a defined corresponding meaning as the first word in the first language; and
displaying the second word in the second language.

20. The computer program product of claim 19, wherein generating the second word in the second language comprises:
generating a plurality of words in the second language that have a defined corresponding meaning as the first word in the first language;
wherein displaying the second word in the second language comprises:
displaying the plurality of words in the second language; and
wherein the operations further comprise:
receiving a selection of one of the plurality of words in the second language.

21. The computer program product of claim 19, wherein receiving the input text comprises:
receiving a first plurality of words in the first language;
wherein generating the second word in the second language comprises:
generating a second plurality of words in the second language that have a defined corresponding meaning as the first plurality of words in the first language; and
wherein the operations further comprise:
displaying the second plurality of words in the second language.

22. The computer program product of claim 21, wherein generating the second plurality of words in the second language comprises:
generating a plurality of word groups in the second language, each of the word groups comprising a plurality of words and having a defined corresponding meaning as the first plurality of words in the first language;
wherein displaying the second plurality of words in the second language comprises:
displaying the plurality of word groups in the second language; and
wherein the operations further comprise:
receiving a selection of one of the plurality of word groups in the second language.

23. The computer program product of claim 21, wherein the first plurality of words in the first language comprises a phrase and the second plurality of words in the second language comprises a phrase.

24. The computer program product of claim 21, wherein the first plurality of words in the first language comprises a sentence and the second plurality of words in the second language comprises a sentence.

25. The computer program product of claim 19, wherein receiving the first word in the first language comprises:
receiving a third word in a third language; and
wherein the operations further comprise:
generating the first word in the first language based on the third word in the third language using a phonetic-based input method editor.

26. The computer program product of claim 19, wherein receiving the first word in the first language comprises:
receiving a third word in a third language; and
wherein the operations further comprise:
generating the first word in the first language based on the third word in the third language using a shape-based input method editor.

27. The computer program product of claim 19, wherein the first language is English and the second language uses CJK characters.
